(19) United States
(12) Patent Application Publication
(10) Pub. No.: US 2014/0043220 A1
(43) Pub. Date: Feb. 13, 2014

(54) LCD DEVICE AND CONTROL SYSTEM OF LCD DEVICE

(71) Applicants: Yinchung Chen, Shenzhen (CN); Liangchan Liao, Shenzhen (CN); Poshen Lin, Shenzhen (CN)

(72) Inventors: Yinchung Chen, Shenzhen (CN); Liangchan Liao, Shenzhen (CN); Poshen Lin, Shenzhen (CN)

(21) Appl. No.: 13/638,006

(22) PCT Filed: Aug. 16, 2012
(86) PCT No.: PCT/CN12/80215

§ 371 Date: Sep. 28, 2012

(30) Foreign Application Priority Data
Aug. 13, 2012 (CN) 201220399014.1

(51) Int. Cl. G09G 3/36

(52) U.S. Cl. 345/87

(57) ABSTRACT

The present disclosure discloses a control system of a liquid crystal display (LCD) device and an LCD device. The control system of the LCD device includes a power supply module, a control circuit board and a scalar board. The scalar board includes a scalar module, a first low-voltage linear voltage stabilizer and a first voltage reduction module used for supplying power to the scalar module and the first low-voltage linear voltage stabilizer. The power supply module outputs 5V that supplies power to the control circuit board and the first voltage reduction module.

### TECHNICAL HELD

The present disclosure relates to the field of liquid crystal displays (LCDs), and more particularly to an LCD device and a control system of an LCD device.

### BACKGROUND

A liquid crystal display (LCD) device includes a plurality of circuit boards. Chip elements of each circuit board are subject to respective voltage reduction treatment according to voltage required by the chip elements. As shown in FIG. 1, typical control system of the LCD device includes a power circuit board, a scalar board, and a control circuit board. Electrical supply is first subject to AC-DC conversion by the power circuit board. 24V is outputted to a converter, and 12V is outputted to the scalar board and the control circuit board for supplying power. The scalar board is configured with two voltage reduction modules, wherein one voltage reduction module is used for reducing the 12V to 5V. The 5V supplies power to a USB/tuner and also supplies power to another voltage reduction module. The 5V is reduced to 3.3V for supplying the power to the scalar module. Because a multilevel voltage reduction mode is adopted, the typical control system of the LCD device has disadvantages of low voltage reduction efficiency, large energy consumption, complicated circuit structure, and inconvenience in reduction of development cycle and cost.

### SUMMARY

In view of the above-described problems, the aim of the present disclosure is to provide a liquid crystal display (LCD) device and a control system of an LCD device capable of reducing utilization of voltage reduction modules.

The aim of the present disclosure is achieved by the following technical scheme:

A control system of an LCD device comprises a power supply module, a control circuit board, and a scalar board. The scalar board comprises a scalar module, a first low-voltage linear voltage stabilizer, and a first voltage reduction module that supplied power to the scalar module and the first low-voltage linear voltage stabilizer. The power supply module outputs 5V to supply the power to the control circuit board and the first voltage reduction module.

Furthermore, the control system of the LCD device comprises a gate driving circuit of a source driving circuit. The control circuit board comprises a sequence control circuit. The source driving circuit and the sequence control circuit are powered by the first voltage reduction module. A main power supply of the sequence control circuit and the source driving circuit are powered by the first voltage reduction module of the scalar board. Thus, the voltage reduction module for supplying power to the main power supply of the sequence control circuit and the source driving circuit in the control circuit board can be omitted. The reusability of the voltage reduction module is improved, and the purpose of reducing cost is achieved. Additionally, each voltage reduction module has additional energy consumption. Thus, the energy consumption is also reduced if the utilization of the voltage reduction modules is reduced.

Furthermore, the control circuit board comprises a second low-voltage linear voltage stabilizer powered by the first voltage reduction module, a first boosted circuit coupled to the 5V of the power supply module, and a charge pump module powered by the first boosted circuit. An output voltage of the second low-voltage linear voltage stabilizer is coupled to the auxiliary power supply end of the sequence control circuit. A panel comprises a gate driving circuit. The output voltage of the first boosted circuit is coupled to the source driving circuit. The charge pump comprises a boosting charge pump and a voltage reduction charge pump. An output voltage of the boosting charge pump and an output voltage of the voltage reduction charge pump are both coupled to the gate driving circuit. The control circuit board is coupled to the scalar board through low-voltage differential signaling (LVDS) cables. This is a layout of a specific control circuit board.

Furthermore, the control system of the LCD device comprises a gate driving circuit of a source driving circuit. The control circuit board comprises a sequence control circuit and a second voltage reduction module. The second voltage reduction module is connected with the 5V outputted by the power supply module. The source driving circuit and the sequence control circuit are powered by the second voltage reduction module. This is a technical scheme of nearest voltage reduction, which is convenient for wiring. Additionally, risks can also be dispersed. The first voltage reduction nodule and the second voltage reduction module are mutually independent, if either voltage reduction nodule is damaged, the normal operation of the other voltage reduction module is not affected.

Furthermore, the control circuit board comprises to second low-voltage linear voltage stabilizer powered by a second voltage reduction module, a first boosted circuit coupled to the 5V of the power supply module, and a charge pump module powered by the first boosted circuit. The output voltage of the second low-voltage linear voltage stabilizer is coupled to the auxiliary power supply end of the sequence control circuit. The panel comprises a gate driving circuit. The output voltage of the first boosted circuit is coupled to the source driving circuit. The charge pump comprises a boosting charge pump and a voltage reduction charge pump. An output voltage of the boosting charge pump and an output voltage of the voltage reduction charge pump are both coupled to the gate driving circuit. The control circuit board is coupled to the scalar board through low-voltage differential signaling (LVDS) cables. This is a layout of another specific control circuit board.

Furthermore, the control system of the LCD device comprises a converter. The power supply module further outputs the 24V to supply power to the converter. The scalar circuit comprises a memory module powered by the first low-voltage linear voltage stabilizer, a USB/tuner module powered by the 5V of the power supply module, and a loudspeaker module coupled to the 24V of the power supply module. The converter and the loudspeaker need higher voltage drive. If the 5V is directly used for boosting, design difficulty and cost are increased and energy consumption is higher. Thus, the power supply module individually outputs the 24V, and simplifies subsequent circuits and the design of the subsequent circuits.

Furthermore, the control system of the LCD device comprises a converter. The power supply module further outputs the 24V to supply power to the converter. The scalar circuit comprises a memory module powered by the first low-voltage linear voltage stabilizer, a USB/tuner module powered by the 5V of the power supply module, and a second boosted circuit coupled to the 5V of the power supply module. Output end of the second boosted circuit coupled to a loudspeaker module. Thus, the power supply module and the scalar board are directly connected by only the 5V, simplifying connecting lines among the circuit boards.

Furthermore, the control system of the LCD device comprises a power circuit board and a converter. The power supply module further outputs the 24V to supply power to the converter. The scalar circuit comprises a first chip and a second chip. The second chip is electronically coupled to the first chip. The first chip comprises the first voltage reduction module and the first low-voltage linear voltage stabilizer. The second chip comprises a scalar module, a memory module and a sequence control circuit. The scalar circuit further comprises a USB/tuner module powered by the 5V of the power supply module. The control circuit board comprises a boosted circuit coupled to the 5V of the power supply module, and a charge pump module powered by the boosted circuit. The panel comprises a source driving circuit and a gate driving circuit. The output voltage of the boosted circuit is coupled to the source driving circuit. The charge pump comprises a boosting charge pump and a voltage reduction charge pump. The output voltage of the boosting charge pump and the output voltage of the voltage reduction charge pump are both coupled to the gate driving circuit. The control circuit board is coupled to the scalar board through flexible flat cable (FTC). In this technical scheme, devices with identical or close voltage are packed and integrated, simplifying the circuits and favoring reduction of development cost. If FFC is adopted, the number of connectors of the system is reduced. For example, four connectors are needed if LVDS is adopted, while only two connectors are needed if FFC is adopted. Moreover, the manufacturing mode is simpler. Thus, FFC adopted favors reduction of the cost.

Furthermore, the control system of the LCD device further comprises a plurality of boosting modules and a plurality of voltage reduction modules. the input ends of the boosting modules and the voltage reduction modules are coupled to the output ends of the boosting modules and the voltage reduction modules that have a voltage that is closest to the voltage of the input ends of the boosting modules and the voltage reduction modules. The voltages with closest voltage levels are used as the input voltages of the boosting modules and the voltage reduction modules, thus reducing the loads of the devices, favoring reduction of heat productivity of the modules and simplifying thermal design. Meanwhile, low-cost devices can also be selected, thus favoring reduction of the cost of the devices.

An LCD device comprises the above-mentioned control system of the LCD device.

The inventor finds through research that main devices of the control system of an LCD panel are powered mostly by the 5V. Thus, in the present disclosure, voltage modules with the 5V output are selected. The devices similar to the USB/tuner can obtain power directly from the power supply module, reducing the utilization of the voltage reduction modules. Meanwhile, multilevel voltage reduction is not needed. The present disclosure reduces the utilization of the voltage reduction modules, does not need multilevel voltage reduction, simplifies the circuit structure, and favors reduction of development cycle and cost.

### BRIEF DESCRIPTION OF FIGURES

FIG. 1 is a schematic diagram of a typical control system of an LCD device.

FIG. 2 is a schematic diagram of a first example of the present disclosure.

FIG. 3 is a schematic diagram of another embodiment of a first example of the present disclosure.

FIG. 4 is a schematic diagram of a second example of the present disclosure.

FIG. 5 is a schematic diagram of a third example of the present disclosure.

Legends: 100. first chip; 200, second chip.

### DETAILED DESCRIPTION

The present disclosure discloses a liquid crystal display (LCD) device comprising a control system of the LCD device. The control system of the LCD device comprises a power supply module, a control circuit board, and a scalar board. The scalar board comprises a scalar module, a first low-voltage linear voltage stabilizer, and a first voltage reduction module that supplies power to the scalar module and the first low-voltage linear voltage stabilizer. The power supply module outputs 5V that supplies the power to the control circuit hoard and the first voltage reduction module.

The inventors find through research that main devices of the control system of an LCD panel are powered mostly by the 5V. Thus, in the present disclosure, voltage modules with the 5V output are selected. The devices similar to the USB/tuner can obtain power directly from the power supply module, reducing utilization of the voltage reduction modules. Meanwhile, multilevel voltage reduction is not needed. The present disclosure reduces the utilization of the voltage reduction modules, does not need multilevel voltage reduction, simplifies a circuit structure and favors reduction of development cycle and cost.

The present disclosure will further be described in detail in accordance with the figures and the preferable examples.

### Example 1

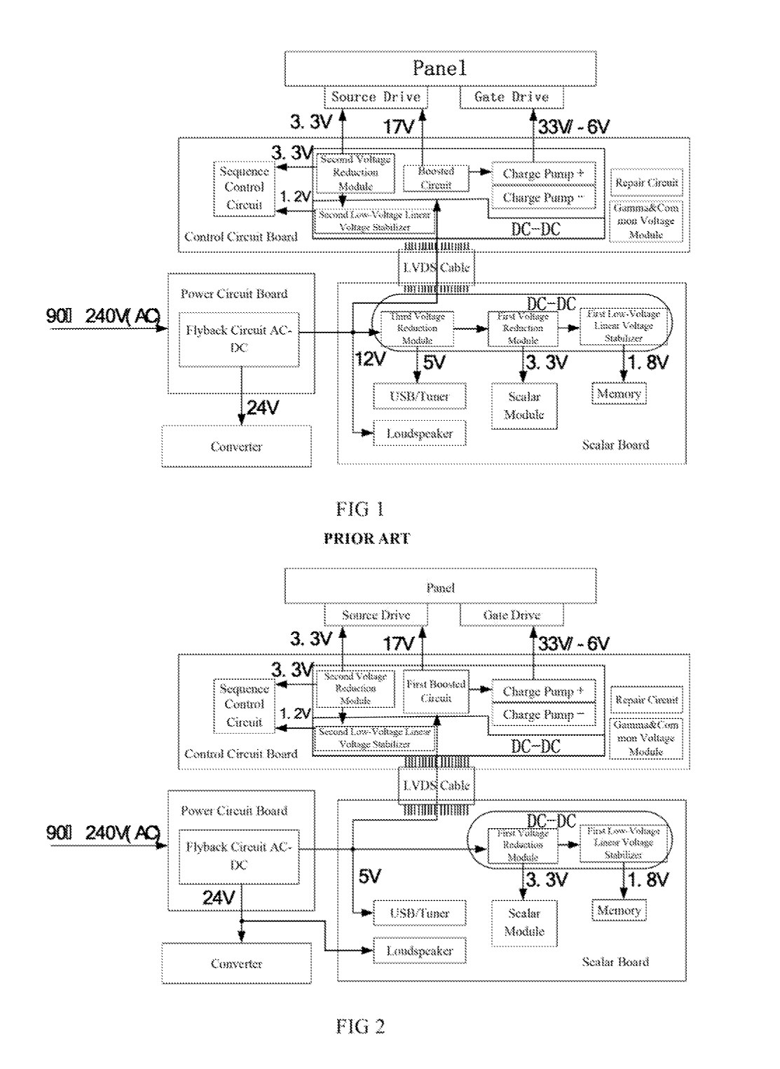

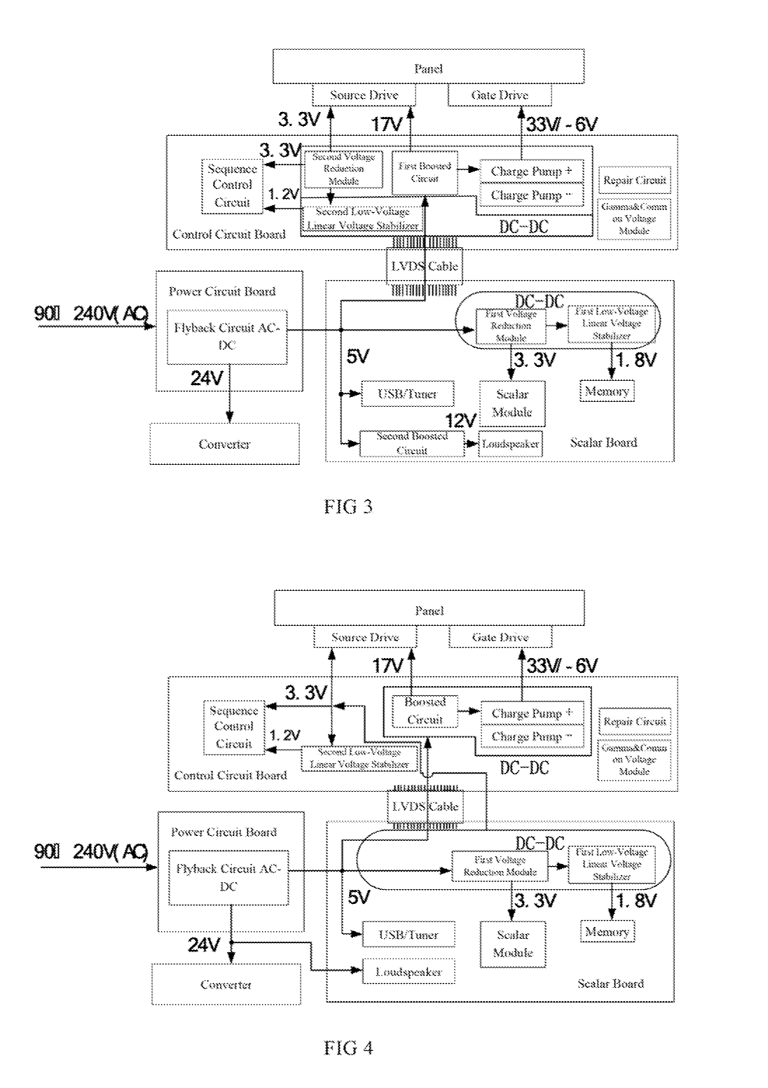

As shown in FIG. 2 and FIG. 3, the control system of the LCD device comprises a power circuit board, a scalar board, a control circuit board, a panel, and a converter. The power circuit board is configured with a flyback circuit (i.e., a power supply module). An input end of the flyback circuit is connected with electric supply of 90 to 240V (AC) to output two groups of voltage level direct current (DC) electric energy of the 5V and the 24V. The 24V supplies power to the converter, and the 5V is connected to the scalar board, and the control circuit board. The panel comprises the source driving circuit and the gate driving circuit.

The scalar board is configured with a first voltage reduction module and a first low-voltage linear voltage stabilizer. The first voltage reduction module is coupled to the 5V of the flyback circuit. The first voltage reduction module outputs the 3.3V that supplies power to the scalar module and the first low-voltage linear voltage stabilizer. The first low-voltage linear voltage stabilizer supplies power to a memory. The first voltage reduction module and the first low-voltage linear voltage stabilizer can be integrated into one chip or designed in lists.

The control circuit board comprises a sequence control circuit, a second low-voltage linear voltage stabilizer, a second voltage reduction module powered by the 5V of the flyback circuit, a boosted circuit coupled to the 5V of the flyback circuit, and a charge pump module powered by the boosted circuit. The second voltage reduction module outputs the 3.3V that is coupled to the second low-voltage linear voltage stabilizer, the main power supply end of the sequence control circuit and the source driving circuit. The second low-voltage linear voltage stabilizer outputs 1.2V. The 1.2V is coupled to the auxiliary power supply end of the sequence control circuit. The control circuit board further comprises a repair circuit module and a gamma & common voltage module. The boosted circuit outputs the 17V for supplying power to the source driving circuit. The charge pump comprises a boosting charge pump and a voltage reduction charge pump. The 33V outputted by the boosting charge pump and −6V outputted by the voltage reduction charge pump are both supplied to the gate driving circuit. The control circuit board is coupled to the scalar board through low-voltage differential signaling (LVDS) cables.

This is a two-level voltage reduction power supply circuit. Because of the small difference between the voltages inputted and outputted by the voltage reduction modules of each level, the voltage resistant requirement for the devices is lower and the heat productivity of the devices is also reduced, favoring selection of low-cost devices and simplification of thermal design.

The USB/tuner of the scalar board and a loudspeaker are directly powered by the flyback circuit. The USB/tuner is powered with the 5V. The loudspeaker is connected with the 24V (as shown in FIG. 2). The converter and the loudspeaker need a higher voltage drive. If the 5V is directly used for boosting, design difficulty and cost are increased and energy consumption is higher. Thus, the power supply module individually outputs the 24V to be able to simplify subsequent circuits and the design of the subsequent circuits.

Optionally, as shown in FIG. 3, a second boosted circuit is added to the scalar board. The second boosted circuit and the USB/tuner are powered with the 5V of the flyback circuit. The second boosted circuit converts the 5V into the 12V for supplying power to the loudspeaker. Thus, the power supply module and the scalar board are directly connected by only the 5V, thereby simplifying connecting lines among the circuit boards.

The example is a technical scheme of nearest voltage reduction. Corresponding voltage reduction modules are arranged in positions near components and parts, which is convenient for wiring. Additionally, risks can also be dispersed. The first voltage reduction module and the second voltage reduction module are mutually independent. If either voltage reduction module is damaged, the normal operation of the other voltage reduction module is not affcted.

### Example 2

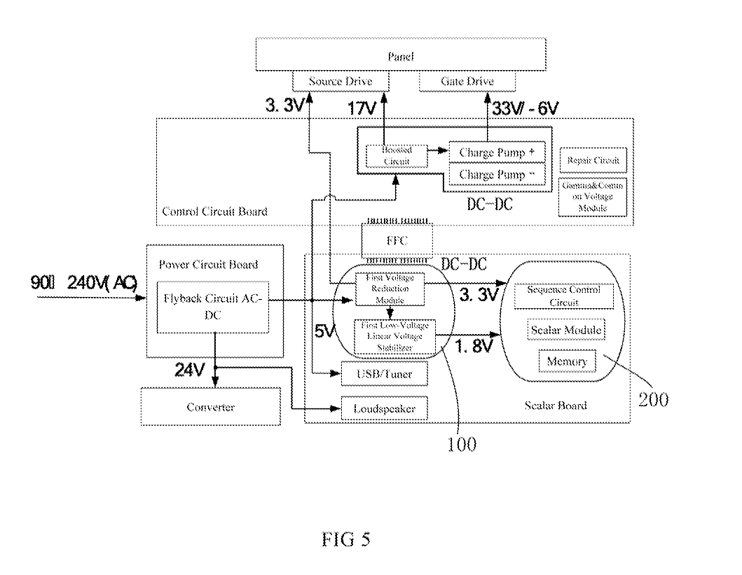

As shown in FIG. 4, the control system of the LCD device comprises a power circuit board, a scalar board, a control circuit board, a panel, and a converter. The power circuit board is configured with a flyback circuit (i.e., a power supply module). The input end of the flyback circuit is connected with electrical supply of 90 to 240V (AC) for outputting two groups of voltage level DC electric energy of the 5V and the 24V. The 24V is used for supplying power to the converter, and the 5V is connected to the scalar board and the control circuit board.

The scalar board is configured with a first voltage reduction module and a first low-voltage linear voltage stabilizer. The first voltage reduction module is coupled with the 5V. The first voltage reduction module outputs the 3.3V. The 3.3V supplies power to the scalar module, the sequence control circuit of the control circuit board and the source driving circuit of the panel as well as the first low-voltage linear voltage stabilizer and the second low-voltage linear voltage stabilizer. The first low-voltage linear voltage stabilizer supplies power to the memory. The first voltage reduction module and the first low-voltage linear voltage stabilizer can be integrated into one chip or designed in lists.

The control circuit board comprises a sequence control circuit, a second low-voltage linear voltage stabilizer, a boosted circuit coupled to the 5V of the flyback circuit, and a charge pump module powered by the boosted circuit. The output voltage of the second low-voltage linear voltage stabilizer is coupled to the auxiliary power supply end of the sequence control circuit. The control circuit board further comprises a repair circuit module and a gamma & common voltage module.

The panel comprises a source driving circuit and a gate driving circuit. The boosted circuit outputs the 17V to the source driving circuit. The charge pump comprises a boosting charge pump and a voltage reduction charge pump. The 33V outputted by the boosting charge pump and −6V outputted by the voltage reduction charge pump are both supplied to the gate driving circuit. The control circuit board is coupled to the scalar board through LVDS cables.

The USB/tuner of the scalar bond and the loudspeaker are directly powered by the flyback circuit. The USB/tuner is powered with the 5V. The loudspeaker is powered with the 24V. Optionally, a second boosted circuit is added to the scalar board. The second boosted circuit and the USB/tuner are powered with the 5V of the flyback circuit. The second boosted circuit converts the 5V into the 12V for supplying power to the loudspeaker.

In the example, a main power supply of the sequence control circuit and a power supply of the source driving circuit are powered by the first voltage reduction module of the scalar board. Thus, the voltage reduction module for supplying power to the main power supply of the sequence control circuit and the source driving circuit in the control circuit board can be omitted. The reusability of the voltage reduction module is improved, and the purpose of reducing cost is achieved. Additionally, each voltage reduction module has additional energy consumption. Thus, the energy consumption is also reduced if the utilization of the voltage reduction modules is reduced.

### Example 3

As shown in FIG. 5, the control system of the LCD device comprises a power circuit board, a scalar board, a control circuit board, a panel, and a converter. The power circuit board is configured with a flyback circuit a power supply module). The input end of the flyback circuit is connected with commercial poser of 90 to 240V (AC) for outputting two groups of voltage level DC electrical energy of the 5V and the 24V. The 24V supplies power to the converter, and the 5V is connected to the scalar board and the control circuit board.

The scalar board comprises a first chip 100 and a second chip 200. The first chip 100 comprises the first voltage reduction module and the first low-voltage linear voltage stabilizer. The second chip 200 comprises a scalar module, a memory module, and a sequence control circuit. The first voltage reduction module is coupled to the 5V and outputs the 3.3V. The 3.3V voltage supplies power to the scalar module, the sequence control circuit of the control circuit board, and the source driving circuit of the panel as well as the first low-voltage linear voltage stabilizer. The first low-voltage linear voltage stabilizer supplies power to the memory. The control circuit board comprises a boosted circuit coupled to the 5V of the flyback circuit, and a charge pump module powered by the boosted circuit. A repair circuit module and a gamma & common voltage module extend on the periphery.

The panel comprises a source driving circuit and a gate driving circuit. The output voltage of the boosted circuit is coupled to the source driving circuit. The charge pump comprises a boosting charge pump and a voltage reduction charge pump. The output voltage of the boosting charge pump and the output voltage of the voltage reduction charge pump are both coupled to the gate driving circuit. The control circuit board is coupled to the scalar board through flexible flat cable (FFC).

The USB/tuner of the scalar board and the loudspeaker are directly powered by the flyback circuit. The USB/tuner is powered with 5V. The loudspeaker is powered with the 24V. Optionally, a second boosted circuit can be added to the scalar board. The second boosted circuit and the USB/tuner are powered with the 5V of the flyback circuit. The second boosted circuit converts the 5V into the 12V for supplying power to the loudspeaker.

In this example, devices with identical or dose voltage are packed and integrated, simplifying the circuits and favoring reduction of development cost. If FFC is adopted, the number of connectors of the system is reduced. For example, four connectors are needed if LVDS is adopted, while only two connectors are needed if ITC is adopted. Moreover, the manufacturing mode of FFC is simpler. Thus, FFC adopted favors reduction of the cost.

The control system of the LCD device of the present disclosure can further comprise a plurality of boosting modules and a plurality of voltage reduction modules. the input ends of the boosting modules and the voltage reduction nodules are coupled to the output ends of the boosting modules and the voltage reduction modules that have a voltage that is closest to the voltage of the input ends of the boosting modules and the voltage reduction modules. The voltages with closest voltage levels are used as the input voltages of the boosting modules and the voltage reduction modules, thus reducing the loads of the devices, favoring reduction of heat productivity of the modules and simplifying thermal design. Meanwhile, low-cost devices can also be selected, thus favoring reduction of the cost of the devices.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

1. A control system of a liquid crystal display (LCD) device, comprising:
a power supply module;
a control circuit board; and
a scalar board comprising a scalar module, a first low-voltage linear voltage stabilizer and a first voltage reduction module that supplies power to the scalar module and the first low-voltage linear voltage stabilizer;
wherein the power supply module outputs 5V to supply power to the control circuit board and the first voltage reduction module;
wherein the control system of the LCD device comprises a power circuit hoard and a converter, and the power supply module outputs 24V to supply power to the converter;
wherein the scalar circuit comprises a first chip and a second chip that is coupled to the first chip; the first chip comprises the first voltage reduction module and the first low-voltage linear voltage stabilizer; the second chip comprises a scalar module, a memory module, and a sequence control circuit;
wherein the scalar circuit further comprises a USB/tuner module powered by the 5V of the power supply module;
wherein the control circuit board comprises a boosted circuit coupled to the 5V of the power supply module, and a charge pump module powered by the boosted circuit;
wherein the panel comprises a source driving circuit and a gate driving circuit; an output voltage of the boosted circuit is coupled to the source driving circuit;
wherein the charge pump comprises a boosting charge pump and a voltage reduction charge pump; an output voltage of the boosting charge pump and an output voltage of the voltage reduction charge pump are both coupled to the gate driving circuit; and
wherein the control circuit board is coupled to the scalar board through a flexible flat cable (FFC).

2. A control system of a liquid crystal display LCD device, comprising:
a power supply module,
a control circuit board and
a scalar board comprising a scalar module, a first low-voltage linear voltage stabilizer and a first voltage reduction module that supplies power to the scalar module and the first low-voltage linear voltage stabilizer;
wherein the power supply module outputs 5V to supply power to the control circuit board and the first voltage reduction module.

3. The control system of the LCD device of claim 2, wherein the control system of the LCD device comprises a gate driving circuit of and a source driving circuit; the control circuit board comprises a sequence control circuit; the source driving circuit and the sequence control circuit are powered by the first voltage reduction module.

4. The control system of the LCD device of claim 3, wherein the control circuit board comprises a second low-voltage linear voltage stabilizer powered by the first voltage reduction module, a first boosted circuit coupled to the 5V of the power supply module, and a charge pump module powered by the first boosted circuit; an output voltage of the second low-voltage linear voltage stabilizer is coupled to an auxiliary power supply end of the sequence control circuit; a panel comprises a gate driving circuit; the output voltage of the first boosted circuit is coupled to the source driving circuit; the charge pump comprises a boosting charge pump and a voltage reduction charge pump; an output voltage of the boosting charge pump and an output voltage of the voltage reduction charge pump are both coupled to the gate driving circuit; the control circuit board is coupled to the scalar board through low-voltage differential signaling (LVDS) cables.

5. The control system of the LCD device of claim 2, wherein the control system of the LCD device comprises a gate driving circuit of and a source driving circuit; the control circuit board comprises a sequence control circuit and a second voltage reduction module; the second voltage reduction module is connected with the 5V outputted by the power supply module; the source driving circuit and the sequence control circuit are powered by the second voltage reduction module.

6. The control system of the LCD device of claim 5, wherein the control circuit board comprises a second low-voltage linear voltage stabilizer powered by a second voltage reduction module, a first boosted circuit coupled to the 5V of the power supply module, and a charge pump module powered by the first boosted circuit; the output voltage of the second low-voltage linear voltage stabilizer is coupled to the auxiliary power supply end of the sequence control circuit; the panel comprises a gate driving circuit; the output voltage of the first boosted circuit is coupled to the source driving circuit; the charge pump comprises a boosting charge pump and a voltage reduction charge pump; an output voltage of the boosting charge pump and an output voltage of the voltage reduction charge pump are both coupled to the gate driving circuit; the control circuit board is coupled to the scalar board through low-voltage differential signaling (LVDS) cables.

7. The control system of the LCD device of claim 2, wherein the control system of the LCD device comprises a converter; the power supply module further outputs the 24V to supply power to the converter; the scalar circuit comprises a memory module powered by the first low-voltage linear voltage stabilizer, a USB/tuner module powered by the 5V of the power supply module, and a loudspeaker module coupled to the 24V of the power supply module.

8. The control system of the LCD device of claim 2, wherein the control system of the LCD device comprises a converter; the power supply module further outputs the 24V to supply power to the converter; the scalar circuit comprises a memory module powered by the first low-voltage linear voltage stabilizer, a USB/tuner module powered by the 5V of the power supply module, and a second boosted circuit coupled to 5V of the power supply module; the output end of the second boosted circuit coupled to a loudspeaker module.

9. The control system of the LCD device of claim 2, wherein the control system of the LCD device comprises a power circuit board and a converter; the power supply module further outputs 24V to supply power to the converter; the scalar circuit comprises a first chip and a second chip; the second chip is electronically coupled to the first chip; the first chip comprises the first voltage reduction module and the first low-voltage linear voltage stabilizer; the second chip comprises a scalar module, a memory module and a sequence control circuit; the scalar circuit further comprises a USB/tuner module powered by the 5V of the power supply module; the control circuit board comprises a boosted circuit coupled to the 5V of the power supply module, and a charge pump module powered by the boosted circuit; the panel comprises a source driving circuit and a gate driving circuit; the output voltage of the boosted circuit is coupled to the source driving circuit the charge pump comprises a boosting charge pump and a voltage reduction charge pump; the output voltage of the boosting charge pump and the output voltage of the voltage reduction charge pump are both coupled to the gate driving circuit; the control circuit board is coupled to the scalar board through a flexible flat cable (FFC).

10. The control system of the LCD device of claim 2, wherein the control system of the LCD device further comprises a plurality of boosting modules and a plurality of voltage reduction modules; the input ends of the boosting modules and the voltage reduction modules are coupled to the output ends of the boosting modules and the voltage reduction modules that have a voltage that is closest to the voltage of the input ends of the boosting modules and the voltage reduction modules.

11. A liquid crystal display (LCD) device, comprising
a control system, wherein the control system comprises a power supply module, a control circuit board, and a scalar board; the scalar board comprises a scalar module, a first low-voltage linear voltage stabilizer, and a first voltage reduction module to supply power to the scalar module and the first low-voltage linear voltage stabilizer;
wherein the power supply module outputs 5V to supply power to the control circuit board, and the first voltage reduction module.

12. The LCD device of claim 11, wherein the control system of the LCD device comprises a gate driving circuit of and a source driving circuit; the control circuit hoard comprises a sequence control circuit; the source driving circuit and the sequence control circuit are powered by the first voltage reduction module.

13. The LCD device of claim 12, wherein the control circuit board comprises a second low-voltage linear voltage stabilizer powered by the first voltage reduction module, a first boosted circuit coupled to the 5V of the power supply module, and a charge pump module powered by the first boosted circuit; the output voltage of the second low-voltage linear voltage stabilizer is coupled to an auxiliary power supply end of the sequence control circuit; the panel comprises a gate driving circuit; the output voltage of the first boosted circuit is coupled to the source driving circuit; the charge pump comprises a boosting charge pump and a voltage reduction charge pump; an output voltage of the boosting charge pump and the output voltage of the voltage reduction charge pump are both coupled to the gate driving circuit; the control circuit board and the scalar board are coupled through low-voltage differential signaling (LVDS) cables.

14. The LCD device of claim 11, wherein the control system of the LCD device comprises a gate driving circuit of and a source driving circuit; the control circuit hoard comprises a sequence control circuit and a second voltage reduction module; the second voltage reduction module is connected with the 5V outputted by the power supply module; the source driving circuit and the sequence control circuit are powered by the second voltage reduction module.

15. The LCD device of claim 14, wherein the control circuit board comprises a second low-voltage linear voltage stabilizer powered by the second voltage reduction module, a first boosted circuit coupled to the 5V of the power supply module, and a charge pump module powered by the first boosted circuit; the output voltage of the second low-voltage linear voltage stabilizer is coupled to the auxiliary power supply end of the sequence control circuit; the panel comprises a gate driving circuit; the output voltage of the first boosted circuit is coupled to the source driving circuit; the charge pump comprises a boosting charge pump and a voltage reduction charge pump; the output voltage of the boosting charge pump and the output voltage of the voltage reduction charge pump are both coupled to the gate driving circuit; the control circuit board is coupled to the scalar board through low-voltage differential signaling (LVDS) cables.

16. The LCD device of claim 11, wherein the control system of the LCD device comprises a converter; the power supply module further outputs the 24V to supply power to the converter; the scalar circuit comprises a memory module powered by the first low-voltage linear voltage stabilizer, a USB/tuner module powered by the 5V of the power supply module, and a loudspeaker module coupled to the 24V of the power supply module.

17. The LCD device of claim 11, wherein the control system of the LCD device comprises a converter; the power supply module further outputs the 24V to supply power to the converter; the scalar circuit comprises a memory module powered by the first low-voltage linear voltage stabilizer, a USB/tuner module powered by the 5V of the power supply module, and a second boosted circuit coupled to the 5V of the power supply module; the output end of the second boosted circuit is coupled to a loudspeaker module.

18. The LCD device of claim 11, wherein the control system of the LCD device comprises a power circuit board and a converter; the power supply module further outputs the 24V to the converter to supply power; the scalar circuit comprises a first chip and a second chip; the second chip is electrically coupled to the first chip; the first chip comprises the first voltage reduction module and the first low-voltage linear voltage stabilizer; the second chip comprises the scalar module, a memory module and a sequence control circuit; the scalar circuit further comprises a USB/tuner module powered by the 5V of the power supply module; the control circuit board comprises a boosted circuit coupled to the 5V of the power supply module, and a charge pump module powered by the boosted circuit; the panel comprises a source driving circuit and a gate driving circuit, the output voltage of the boosted circuit is coupled to the source driving circuit; the charge pump comprises a boosting charge pump and a voltage reduction charge pump; the output voltage of the boosting charge pump and the output voltage of the voltage reduction charge pump are both coupled to the gate driving circuit; the control circuit board is coupled to the scalar board throng flexible flat cable (FFC).

19. The LCD device of claim 11, wherein the control system of the LCD device further comprises a plurality of boosting modules and a plurality of voltage reduction modules; input ends of the boosting modules and the voltage reduction modules are coupled to output ends of the boosting modules and the voltage reduction modules that have a voltage that is closest to the voltage of the input ends of the boosting modules and the voltage reduction modules.
